(19) United States
(12) Patent Application Publication
(10) Pub. No.: US 2003/0133507 A1
(43) Pub. Date: Jul. 17, 2003

(54) Adaptive inverse transformation device

(76) Inventors: Carolina Miro Sorolla, Saint Nom la Breteche (FR); Joseph Adelaide, Montigny le Bretonneux (FR); Juliette Dhuisme, Torcy (FR)

Correspondence Address: PHILIPS ELECTRONICS NORTH AMERICAN CORP, 580 WHITE PLAINS RD, TARRYTOWN, NY, 10591, US

(21) Appl. No.: 10/326,019

(22) Filed: Dec. 20, 2002

(30) Foreign Application Priority Data
Dec. 28, 2001 (FR) 0116998

(51) Int. Cl. H04N 7/12

(52) U.S. Cl. 375/240.25

(57) ABSTRACT

The present invention relates to a device for the inverse transformation of transformed data (X) into inversely transformed data (x) via an inverse transformation matrix which can be decomposed into submatrices along a diagonal of the matrix. Said device comprises permutation means (11) able to reorder the transformed data according to the number of data to be processed. It also comprises scalable calculation modules (12, 13, 14, 15) able to effect a product of reordered transformed data and of a submatrix. Finally, it comprises linear combination means (16, 17, 18) able to linearly combine the data issuing from the scalable calculation modules according to the number of data to be processed.

### FIELD OF THE INVENTION

The present invention relates to a method and device for the inverse transformation of transformed data into inversely transformed data via an inverse transformation matrix.

It also relates to a method and device for transforming original data into transformed data via a transformation matrix.

It finds its application in the field of the compression/decompression of digital video data, these data being for example of the MPEG (from the English “Motion Picture Expert Group”) type, in particular for apparatus such as digital television sets, video coders and decoders of the MPEG2 or MPEG4 type, data storage devices or mobile telephones.

### BACKGROUND OF THE INVENTION

The properties of discrete cosine transformation or DCT cause it to fulfill an essential role in the field of the compression of sequences of images. Conversely, with regard to the video decoder, the reconstruction of the sequence of images is provided by virtue of an inverse discrete cosine transformation or IDCT. Direct and inverse discrete cosine transformations are used in many video standards such as JPEG, MPEG-1, MPEG-2, MPEG-4 or H263 amongst others.

International patent application WO99/10818 describes an example of implementation of a two-dimensional inverse discrete cosine transformation. According to this state of the art, a block of N×N data is inversely transformed, column by column, by virtue of a first processor able to effect a unidimensional inverse discrete cosine transformation. The intermediate results issuing from this first processor are then stored temporarily in a transposition memory. When all the columns have been processed, the intermediate results are inversely transformed row by row by virtue of a second processor able to effect a unidimensional inverse discrete cosine transformation. The results issuing from the second processor constitute the final result of the two-dimensional inverse discrete cosine transformation. In the embodiment described in the international patent application, the blocks to be processed comprise 16 rows of 16 data items and are decomposed into blocks of reduced size, respectively 8×8, 4×4 and 2×2 data items. A calculation structure of the butterfly type then simplifies the calculation of the two-dimensional inverse discrete cosine transformation of the block of 16×16 data items.

New video applications are introducing new functionalities which increase the complexity of the hardware implementation of discrete cosine transformations. This implementation must make it possible to perform such transformations, where necessary in parallel for different video flows, on blocks of different sizes, for example 2×2 data for a mosaic coder/decoder, 4×4 data for an H26L coder/decoder, 8×8 data for an MPEG-2 or 4 coder/decoder, and 16×16 data for a JPEG2000 coder/decoder or for certain post-processing algorithms. In addition, the hardware implementation must be simple so as to take account of the low power of certain low-rate applications such as mobile telephones. However, the state of the art is not adapted for, in a simple fashion, effecting an inverse discrete cosine transformation which is scalable, i.e. on blocks of different sizes. Some inputs of the device implementing the inverse discrete cosine transformation could possibly be used for calculating transformations of blocks of 2×2 data, 4×4 data or 8×8 data, but it would then be necessary to perform all the calculation steps in order to have the final result even for a 2×2 IDCT transformation. The result would be excessive complexity for the calculation of an inverse discrete cosine transformation of this type.

### SUMMARY OF THE INVENTION

The aim of the present invention is to propose a method and device for direct or inverse transformation via a transformation matrix which make it possible to perform a transformation on blocks of different sizes with limited calculation resources.

To this end, the inverse transformation device according to the invention uses an inverse transformation matrix decomposed into submatrices along a diagonal of the matrix, and comprises:

permutation means able to reorder the transformed data according to a number of data items to be processed,

scalable calculation modules able to produce a product of reordered transformed data and of a submatrix,

linear combination means able to linearly combine the data issuing from the scalable calculation modules according to the number of data to be processed.

To this end, the transformation device according to the invention uses a transformation matrix decomposed into submatrices along a diagonal of the matrix, and comprises:

linear combination means able to linearly combine the original data,

scalable calculation modules able to produce a product of data issuing from the linear combination means and of a submatrix,

permutation means able to reorder the data issuing from the scalable calculation modules according to a number of data to be processed, in order to supply the transformed data.

By making the transformation matrix symmetrical, calculating a bidimensional transformation amounts to modular matrix calculations according to the number of data to be processed and simple linear combinations. Thus such a transformation device performs a number of operations proportional to the size of the block to be processed and therefore to the complexity of the transformation. This solution is simple and requires only limited calculation resources. In addition, the fact that the transformation device is able to make modular calculations makes it possible to calculate scalable bidimensional transformations and makes the transformation device capable of integration in a multistandard decoder.

### BRIEF DESCRIPTION OF THE DRAWINGS

The invention will be further described with reference to examples of embodiments shown in the drawings to which, however, the invention is not restricted.

FIG. 1 shows the structure of an inverse transformation device according to the invention,

FIGS. 2a, 2b, 2c and 2d show the permutation means of the inverse transformation device according to the invention for various configurations,

FIGS. 3a, 3b and 3c show scalable calculation modules of the inverse transformation device according to the invention, respectively for calculating a 2×2, 4×4 and 8×8 IDCT,

FIGS. 4a and 4b show linear combination means, respectively for the calculation of a 4×4 and 8×8 IDCT,

FIG. 5 depicts a device for decompressing compressed digital video data comprising an inverse transformation device according to the invention, and

FIG. 6 shows a device for compressing digital video data comprising a direct transformation device according to the invention.

### DESCRIPTION OF PREFERRED EMBODIMENTS

Hereinafter the present invention is described in the case of direct and inverse discrete cosine transformations. However, it will be clear to a person skilled in the art that the invention is applicable to any transformation of the Fourier or equivalent type, whenever the transformation matrix can be decomposed into submatrices along a diagonal of the transformation matrix.

Consider first of all the case of a bidimensional inverse discrete cosine transformation. Said transformation makes it possible to transform data in the frequency domain—these will be referred to subsequently as transformed data (X)—into the time domain—they will be referred to subsequently as inversely transformed data (x)—using the following equation:

$$x ( m , n ) = {\sum }_{i = 0}^{N - 1} {\sum }_{j = 0}^{N - 1} c ( i , j ) \cdot cos \frac{π ( 2 m + 1 ) i}{2 N} \cdot cos \frac{π ( 2 n + 1 ) j}{2 N} \cdot X ( i , j ) = Mi ( i , j ) \cdot X ( i , j )$$

As the inverse discrete cosine transformation device is situated in consumer electronic devices, it must be designed to function at high rate, with great flexibility and minimum complexity.

For this purpose, the inverse transformation matrix Mi can be decomposed into submatrices along a diagonal of said matrix, according to the following method, described in the case of an 8×8 inverse transformation matrix.

Originally the inverse transformation matrix Mi_{8×8} is as follows:

$${Mi}_{8 * 8} = \frac{1}{2} ( \begin{matrix}\frac{1}{\sqrt{2}} & cos \frac{π}{16} & cos \frac{2 π}{16} & cos \frac{3 π}{16} & cos \frac{4 π}{16} & cos \frac{5 π}{16} & cos \frac{6 π}{16} & cos \frac{7 π}{16} \\ \frac{1}{\sqrt{2}} & cos \frac{3 π}{16} & cos \frac{6 π}{16} & - cos \frac{7 π}{16} & - cos \frac{4 π}{16} & - cos \frac{π}{16} & - cos \frac{2 π}{16} & - cos \frac{5 π}{16} \\ \frac{1}{\sqrt{2}} & cos \frac{5 π}{16} & - cos \frac{6 π}{16} & - cos \frac{π}{16} & - cos \frac{4 π}{16} & cos \frac{7 π}{16} & cos \frac{2 π}{16} & cos \frac{2 π}{16} \\ \frac{1}{\sqrt{2}} & cos \frac{7 π}{16} & - cos \frac{2 π}{16} & - cos \frac{5 π}{16} & cos \frac{4 π}{16} & cos \frac{3 π}{16} & - cos \frac{6 π}{16} & - cos \frac{π}{16} \\ \frac{1}{\sqrt{2}} & - cos \frac{7 π}{16} & - cos \frac{2 π}{16} & cos \frac{5 π}{16} & cos \frac{4 π}{16} & - cos \frac{3 π}{16} & - cos \frac{6 π}{16} & cos \frac{π}{16} \\ \frac{1}{\sqrt{2}} & - cos \frac{5 π}{16} & - cos \frac{6 π}{16} & cos \frac{π}{16} & - cos \frac{4 π}{16} & - cos \frac{7 π}{16} & cos \frac{2 π}{16} & - cos \frac{3 π}{16} \\ \frac{1}{\sqrt{2}} & - cos \frac{3 π}{16} & cos \frac{6 π}{16} & cos \frac{7 π}{16} & - cos \frac{4 π}{16} & cos \frac{π}{16} & - cos \frac{2 π}{16} & cos \frac{5 π}{16} \\ \frac{1}{\sqrt{2}} & - cos \frac{π}{16} & cos \frac{2 π}{16} & - cos \frac{3 π}{16} & cos \frac{4 π}{16} & - cos \frac{5 π}{16} & cos \frac{6 π}{16} & - cos \frac{7 π}{16}\end{matrix} )$$

This matrix is simplified using the value

$$cos ( \frac{π}{4} ) = \frac{1}{\sqrt{2}}$$

and factorizing by

$$\frac{1}{\sqrt{2}}$$

which gives:

$${Mi}_{8 * 8} = \frac{1}{2 \sqrt{2}} ( \begin{matrix}1 & \sqrt{2} cos \frac{π}{16} & \sqrt{2} cos \frac{π}{8} & \sqrt{2} cos \frac{3 π}{16} & 1 & \sqrt{2} cos \frac{5 π}{16} & \sqrt{2} cos \frac{3 π}{8} & \sqrt{2} cos \frac{7 π}{16} \\ 1 & \sqrt{2} cos \frac{3 π}{16} & \sqrt{2} cos \frac{3 π}{8} & - \sqrt{2} cos \frac{7 π}{16} & - 1 & - \sqrt{2} cos \frac{π}{16} & - \sqrt{2} cos \frac{π}{8} & - \sqrt{2} cos \frac{5 π}{16} \\ 1 & \sqrt{2} cos \frac{5 π}{16} & - \sqrt{2} cos \frac{3 π}{8} & - \sqrt{2} cos \frac{π}{16} & - 1 & \sqrt{2} cos \frac{7 π}{16} & \sqrt{2} cos \frac{π}{8} & \sqrt{2} cos \frac{3 π}{16} \\ 1 & \sqrt{2} cos \frac{7 π}{16} & - \sqrt{2} cos \frac{π}{8} & - \sqrt{2} cos \frac{5 π}{16} & 1 & \sqrt{2} cos \frac{3 π}{16} & - \sqrt{2} cos \frac{3 π}{8} & - \sqrt{2} cos \frac{π}{16} \\ 1 & - \sqrt{2} cos \frac{7 π}{16} & - \sqrt{2} cos \frac{π}{8} & \sqrt{2} cos \frac{5 π}{16} & 1 & - \sqrt{2} cos \frac{3 π}{16} & - \sqrt{2} cos \frac{3 π}{8} & \sqrt{2} cos \frac{π}{16} \\ 1 & - \sqrt{2} cos \frac{5 π}{16} & - \sqrt{2} cos \frac{3 π}{8} & \sqrt{2} cos \frac{π}{16} & - 1 & - \sqrt{2} cos \frac{7 π}{16} & \sqrt{2} cos \frac{π}{8} & - \sqrt{2} cos \frac{3 π}{16} \\ 1 & - \sqrt{2} cos \frac{3 π}{16} & \sqrt{2} cos \frac{3 π}{8} & \sqrt{2} cos \frac{7 π}{16} & - 1 & \sqrt{2} cos \frac{π}{16} & - \sqrt{2} cos \frac{π}{8} & \sqrt{2} cos \frac{5 π}{16} \\ 1 & - \sqrt{2} cos \frac{π}{16} & \sqrt{2} cos \frac{π}{8} & - \sqrt{2} cos \frac{3 π}{16} & 1 & - \sqrt{2} cos \frac{5 π}{16} & \sqrt{2} cos \frac{3 π}{8} & - \sqrt{2} cos \frac{7 π}{16}\end{matrix} )$$

The second and fifth columns are then permuted, as are the fourth and seventh columns, which gives Mi_{8×8}=A_{8×8}.P₈ with A_{8×8} such that:

$$\begin{matrix}{A}_{8 * 8} = \frac{1}{2 \sqrt{2}} ( \begin{matrix}1 & 1 & \sqrt{2} cos \frac{π}{8} & \sqrt{2} cos \frac{3 π}{8} & \sqrt{2} cos \frac{π}{16} & \sqrt{2} cos \frac{5 π}{16} & \sqrt{2} cos \frac{3 π}{16} & \sqrt{2} cos \frac{7 π}{16} \\ 1 & - 1 & \sqrt{2} cos \frac{3 π}{8} & - \sqrt{2} cos \frac{π}{8} & \sqrt{2} cos \frac{3 π}{16} & - \sqrt{2} cos \frac{π}{16} & - \sqrt{2} cos \frac{7 π}{16} & - \sqrt{2} cos \frac{5 π}{16} \\ 1 & - 1 & - \sqrt{2} cos \frac{3 π}{8} & \sqrt{2} cos \frac{π}{8} & \sqrt{2} cos \frac{5 π}{16} & \sqrt{2} cos \frac{7 π}{16} & - \sqrt{2} cos \frac{π}{16} & \sqrt{2} cos \frac{3 π}{16} \\ 1 & 1 & - \sqrt{2} cos \frac{π}{8} & - \sqrt{2} cos \frac{3 π}{8} & \sqrt{2} cos \frac{7 π}{16} & \sqrt{2} cos \frac{3 π}{16} & - \sqrt{2} cos \frac{5 π}{16} & - \sqrt{2} cos \frac{π}{16} \\ 1 & 1 & - \sqrt{2} cos \frac{π}{8} & - \sqrt{2} cos \frac{3 π}{8} & - \sqrt{2} cos \frac{7 π}{16} & - \sqrt{2} cos \frac{3 π}{16} & \sqrt{2} cos \frac{5 π}{16} & \sqrt{2} cos \frac{π}{16} \\ 1 & - 1 & - \sqrt{2} cos \frac{3 π}{8} & \sqrt{2} cos \frac{π}{8} & - \sqrt{2} cos \frac{5 π}{16} & - \sqrt{2} cos \frac{7 π}{16} & \sqrt{2} cos \frac{π}{16} & - \sqrt{2} cos \frac{3 π}{16} \\ 1 & - 1 & \sqrt{2} cos \frac{3 π}{8} & - \sqrt{2} cos \frac{π}{8} & - \sqrt{2} cos \frac{3 π}{16} & \sqrt{2} cos \frac{π}{16} & \sqrt{2} cos \frac{7 π}{16} & \sqrt{2} cos \frac{5 π}{16} \\ 1 & 1 & \sqrt{2} cos \frac{π}{8} & \sqrt{2} cos \frac{3 π}{8} & - \sqrt{2} cos \frac{π}{16} & - \sqrt{2} cos \frac{5 π}{16} & - \sqrt{2} cos \frac{3 π}{16} & - \sqrt{2} cos \frac{7 π}{16}\end{matrix} ) , \\ and {P}_{8} = ( \begin{matrix}1 & 0 & 0 & 0 & 0 & 0 & 0 & 0 \\ 0 & 0 & 0 & 0 & 1 & 0 & 0 & 0 \\ 0 & 0 & 1 & 0 & 0 & 0 & 0 & 0 \\ 0 & 0 & 0 & 0 & 0 & 0 & 1 & 0 \\ 0 & 1 & 0 & 0 & 0 & 0 & 0 & 0 \\ 0 & 0 & 0 & 0 & 0 & 1 & 0 & 0 \\ 0 & 0 & 0 & 1 & 0 & 0 & 0 & 0 \\ 0 & 0 & 0 & 0 & 0 & 0 & 0 & 1\end{matrix} ) .\end{matrix}$$

Using the symmetries of the A_{8×8} matrix, the transformation matrix Mi_{8×8} can be decomposed as follows: Mi_{8×8}=S_{8,8}·S_{4,8}·B_{8,8}·P₈ with:

$${S}_{8 , 8} = ( \begin{matrix}1 & 0 & 0 & 0 & 0 & 0 & 0 & 1 \\ 0 & 1 & 0 & 0 & 0 & 0 & 1 & 0 \\ 0 & 0 & 1 & 0 & 0 & 1 & 0 & 0 \\ 0 & 0 & 0 & 1 & 1 & 0 & 0 & 0 \\ 0 & 0 & 0 & 1 & - 1 & 0 & 0 & 0 \\ 0 & 0 & 1 & 0 & 0 & - 1 & 0 & 0 \\ 0 & 1 & 0 & 0 & 0 & 0 & - 1 & 0 \\ 1 & 0 & 0 & 0 & 0 & 0 & 0 & - 1\end{matrix} ) , {S}_{4 , 8} = ( \begin{matrix}1 & 0 & 0 & 1 & 0 & 0 & 0 & 0 \\ 0 & 1 & 1 & 0 & 0 & 0 & 0 & 0 \\ 0 & 1 & - 1 & 0 & 0 & 0 & 0 & 0 \\ 1 & 0 & 0 & - 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ) = ( \begin{matrix}{S}_{4 , 4} & {0}_{4 , 4} \\ {0}_{4 , 4} & {I}_{4 , 4}\end{matrix} ) ,$$

where 0_{4,4} and I_{4×4} are respectively the null matrix and the identity matrix of 4 rows by 4 columns, and:

$${B}_{8 , 8} = \frac{1}{2 \sqrt{2}} ( \begin{matrix}M1 & {0}_{2 , 2} & {0}_{2 , 4} \\ {0}_{2 , 2} & M2 & {0}_{2 , 4} \\ {0}_{4 , 2} & {0}_{4 , 2} & M3\end{matrix} ) where M1 = ( \begin{matrix}1 & 1 \\ 1 & - 1\end{matrix} ) , M2 = ( \begin{matrix}\sqrt{2} cos \frac{3 π}{8} & - \sqrt{2} cos \frac{π}{8} \\ \sqrt{2} cos \frac{π}{8} & \sqrt{2} cos \frac{3 π}{8}\end{matrix} )$$

$$and M3 = ( \begin{matrix}\sqrt{2} cos \frac{7 π}{16} & \sqrt{2} cos \frac{3 π}{16} & - \sqrt{2} cos \frac{5 π}{16} & - \sqrt{2} cos \frac{π}{16} \\ \sqrt{2} cos \frac{5 π}{16} & \sqrt{2} cos \frac{7 π}{16} & - \sqrt{2} cos \frac{π}{16} & \sqrt{2} cos \frac{3 π}{16} \\ \sqrt{2} cos \frac{3 π}{16} & - \sqrt{2} cos \frac{π}{16} & - \sqrt{2} cos \frac{7 π}{16} & - \sqrt{2} cos \frac{π}{16} \\ \sqrt{2} cos \frac{π}{16} & \sqrt{2} cos \frac{5 π}{16} & \sqrt{2} cos \frac{3 π}{16} & \sqrt{2} cos \frac{7 π}{16}\end{matrix} ) .$$

The same decomposition into submatrices is effected on a 16×16 inverse transformation matrix: Mi_{16×16}=S_{16,16}·S_{8,16}·S_{4,16}·B_{16×16}·P₁₆ with

$${S}_{16 , 16} = ( \begin{matrix}1 & & & & & 1 \\ & \cdot & & & \cdot & \\ & & 1 & 1 & & \\ & & 1 & - 1 & & \\ & \cdot & & & \cdot & \\ 1 & & & & & - 1\end{matrix} ) , {S}_{8 , 16} = ( \begin{matrix}{S}_{8 , 8} & {0}_{8 , 8} \\ {0}_{8 , 8} & {I}_{8 , 8}\end{matrix} ) , {S}_{4 , 16} = ( \begin{matrix}{S}_{4 , 4} & {0}_{4 , 12} \\ {0}_{12 , 4} & {I}_{12 , 12}\end{matrix} ) , and$$

$${B}_{16 , 16} = \frac{1}{2 \sqrt{2}} ( \begin{matrix}M1 & {0}_{2 , 2} & {0}_{2 , 4} & {0}_{2 , 8} \\ {0}_{2 , 2} & M2 & {0}_{2 , 4} & {0}_{2 , 8} \\ {0}_{4 , 2} & {0}_{4 , 2} & M3 & {0}_{4 , 8} \\ {0}_{8 , 2} & {0}_{8 , 2} & {0}_{8 , 4} & M4\end{matrix} ) .$$

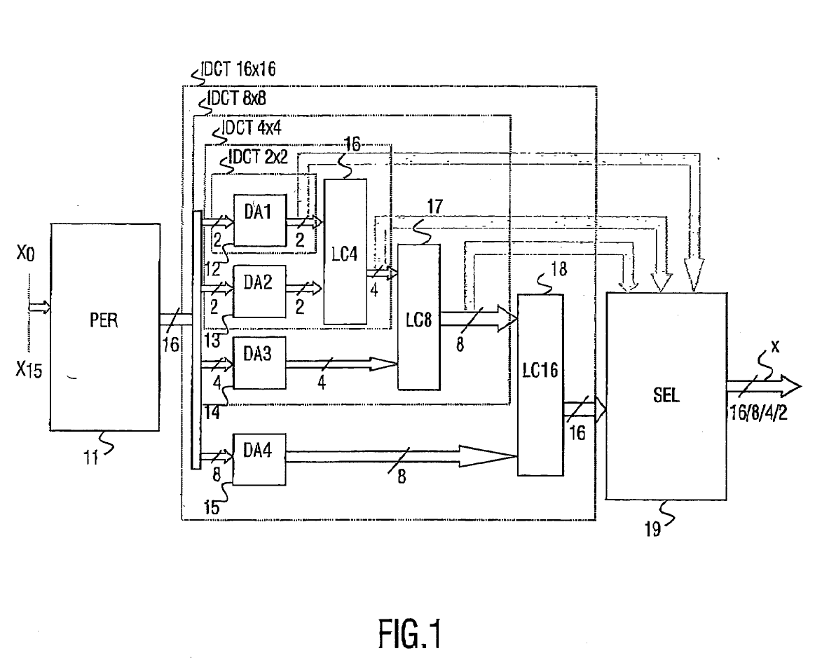

FIG. 1 shows the structure of an inverse transformation device according to the invention. This device implements a scalable inverse discrete cosine transformation IDCT able to process blocks of 2×2, 4×4, 8×8 and 16×16 data. For this it comprises:

permutation means PER (11) able to reorder the transformed data (X) according to a number of data to be processed, which may be 2, 4, 8 or 16 according to the size of the block to be processed;

scalable calculation modules DA1 to DA4 (12, 13, 14, 15), able to effect a product of reordered transformed data and a submatrix, the module DA1 processing the blocks of 2×2 transformed data by means of the submatrix M1, the modules DA1 and DA2 processing the blocks of 4×4 data transformed by means respectively of the submatrices M1 and M2, the modules DA1, DA2 and DA3 processing the blocks of 8×8 data transformed by means respectively of the submatrices M1, M2 and M3, and the modules DA1, DA2, DA3 and DA4 processing the blocks of 16×16 data transformed respectively by means of the submatrices M1, M2, M3 and M4;

linear combination means LC4 to LC16 (16, 17, 18), able to linearly combine the data issuing from the scalable calculation modules according to the number of data to be processed, the means LC4 using the matrix S_{4,4} and linearly combining the outputs of the modules DA1 and DA2, the means LC8 using the matrix S_{8,8} and linearly combining the outputs of the module DA3 and of the means LC4, and the means LC16 using the matrix S_{16,16} and linearly combining the outputs of the module DA4 and of the means LC8;

selection means SEL (19), able to select the data issuing from the first scalable calculation modules DA1 (12), and from the linear combination means LC4, LC8 and LC16 (16, 17, 18) according to the number of data to be processed, in order to supply respectively blocks of 2×2, 4×4, 8×8 and 16×16 inversely transformed data.

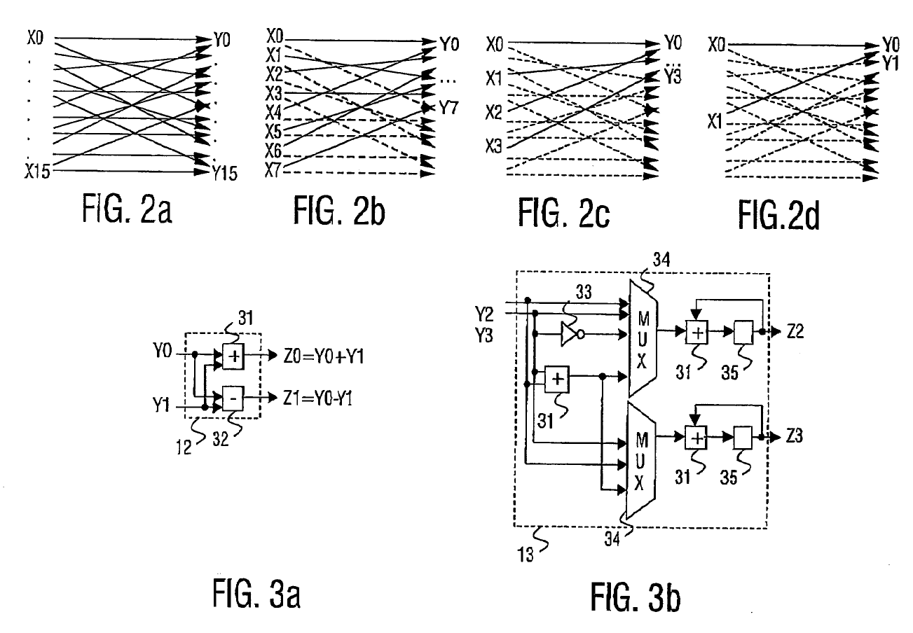

FIGS. 2a to 2d depict the permutation means of the inverse transformation device according to the invention, in various configurations. The product of the permutation matrix P16 and a column of a block of 16×16 transformed data X results in a column of a block of intermediate data Y. In the case of an IDCT transformation of 16×16 transformed data X, the permutation of the data is performed by interconnection circuits depicted in FIG. 2a, Y0 corresponding to X0, Y1 corresponding to X8, Y2 to X4 and so on. It is repeated by dotted arrows in FIGS. 2b to 2d.

The permutation means also make it possible to reorder the transformed data whatever the number of data to be processed. Thus, in the case of an 8×8 IDCT transformation, the data input to the permutation means are distributed one every two inputs according to the diagram in FIG. 2b. Thus the wiring, of the permutation means remains identical, Y0 corresponding to X0, Y1 corresponding now to X4, Y2 to X2 and so on. According to a similar principle, the data input to the permutation means are distributed one every four inputs according to the diagram in FIG. 2c in the case of a 4×4 IDCT transformation. Thus Y0 corresponds to X0, Y1 to X2, Y2 to X1 and Y3 to X3. Finally, the data at the input of the permutation means are distributed one every eight inputs according to the diagram in FIG. 2d in the case of a 2×2 IDCT transformation, Y0 corresponding to X0 and Y1 to X1.

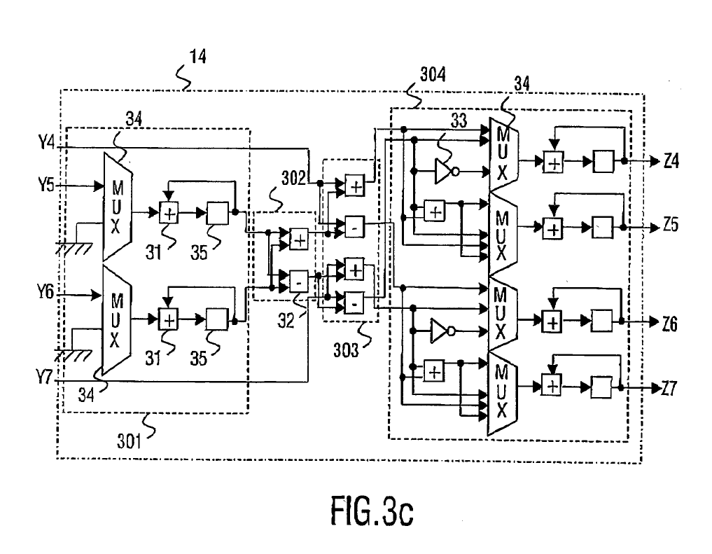

FIGS. 3a, 3b and 3c depict scalable calculation modules of the inverse transformation device according to the invention, respectively for calculating a 2×2, 4×4 and 8×8 IDCT transformation. These scalable calculation means are based on distributed arithmetic algorithms. According to a first principle, based on a ROM memory of the read only type, these algorithms make it possible to sequentially make shifts to the right and additions of values. The advantage of this technique is the reduction in the calculation complexity since the multipliers have been omitted. However, use of the ROM memory may be problematic the case of transformation matrices of large size. According to a more advantageous principle, the distributed arithmetic algorithms are based on a series of shifts and accumulations.

In the case of a 2×2 IDCT transformation, the scalable calculation module DA1 (12) is depicted in FIG. 3a. It receives the data Y0 and Y1 and implements their product with the submatrix M1. For this purpose it comprises simply an adder (31) effecting the sum Z0 of Y0 and Y1 and a subtractor (32) effecting the subtraction Z1=Y0−Y1.

In the case of a 4×4 IDCT transformation, the scalable calculation module DA2 (13) is shown in FIG. 3b. It receives the data Y2 and Y3 and implements their product with the submatrix M2. For this purpose it comprises an inverter (33) able to invert Y3, an adder (31) able to add Y2 and Y3, and two multiplexers MUX (34) able to select an input amongst their various inputs Y2, Y3, Y2+Y3 and −Y3. Finally, it comprises two sets of an adder (31) and a shift register (35), able to calculate a final result (Z2, Z3) according to the principle of shifts and accumulations.

For example, if it is wished to calculate the following product:

$$( \begin{matrix}{A}_{1} & {A}_{2} \\ {A}_{3} & {A}_{4}\end{matrix} ) ( \begin{matrix}Y2 \\ Y3\end{matrix} )$$

The product of the first row and the first column involves calculating: A₁Y2+A₂Y3.

A₁ and A₂ are calculated according to their binary value in two's complement code. For example, if A₁=1011101001 and A₂=0100101000, it is therefore necessary to calculate:

Y2*2⁰+Y3*2⁻¹+Y2*2⁻²+Y2*2⁻³+(Y2+Y3)*2⁻⁴+(Y2+Y3)*2⁻⁶+Y2*2⁻⁹.

The operation to be performed is therefore as follows:

Y2+(Y3+(Y2+(Y2+((Y2+Y3)+(0+((Y2+Y3)+(0+(0+(Y2*2⁻¹))*2⁻¹)*2⁻¹)*2⁻¹)*2⁻¹)*2⁻¹)*2⁻¹)*2⁻¹)*2⁻¹.

The multiplexer MUX makes it possible to choose here one input amongst X₁, X₄, X₁+X₄ and 0. It supplies at its output first of all the data item having the smallest power, that is to say here Y2, and then the data item is shifted by one bit to the right, which amounts to effecting a product of Y2 and 2⁻¹. Then, during the following two clock cycles, the multiplexer supplies the null value; the intermediate result is then Y2*2⁻³. Then it supplies the data item Y2+Y3 during the fourth clock cycle and so on until the final result Y2*2⁰+Y3*2⁻¹+Y2*2⁻²+Y2*2⁻³(Y2+Y3)*2⁻⁴+(Y2+Y3)*2⁻⁶+Y2*2⁻⁹ is obtained at an output of the scalable calculation module.

In the case of an 8×8 IDCT transformation, the scalable calculation module DA3 (13) is shown in FIG. 3c. It receives the data Y4 to Y7 and implements their product with the submatrix M3. For this purpose the submatrix M3 is again decomposed into a product of 4 submatrices M31, M32, M33 and M34 such that:

$$M31 = ( \begin{matrix}\sqrt{2} cos \frac{7 π}{16} & 0 & 0 & - \sqrt{2} cos \frac{π}{16} \\ 0 & \sqrt{2} cos \frac{3 π}{16} & - \sqrt{2} cos \frac{5 π}{16} & 0 \\ 0 & - \sqrt{2} cos \frac{5 π}{16} & - \sqrt{2} cos \frac{3 π}{16} & 0 \\ \sqrt{2} cos \frac{π}{16} & 0 & 0 & \sqrt{2} cos \frac{7 π}{16}\end{matrix} ) , M32 = ( \begin{matrix}1 & 1 & 0 & 0 \\ 1 & - 1 & 0 & 0 \\ 0 & 0 & 1 & 1 \\ 0 & 0 & - 1 & 1\end{matrix} ) , M33 = ( \begin{matrix}1 & 0 & 0 & 0 \\ 0 & 1 & 1 & 0 \\ 0 & - 1 & 1 & 0 \\ 0 & 0 & 0 & 1\end{matrix} ) and M34 = ( \begin{matrix}1 & 0 & 0 & 0 \\ 0 & \frac{1}{\sqrt{2}} & 0 & 0 \\ 0 & 0 & \frac{1}{\sqrt{2}} & 0 \\ 0 & 0 & 0 & 1\end{matrix} )$$

The scalable calculation module DA3 (14) comprises four stages in cascade, each stage corresponding to one of the submatrices M31, M32, M33 and M34. The first stage (301) receives the data Y4 to Y7 and implements their product with the submatrix M31. It comprises two multiplexers (34) receiving respectively Y5 and the null value on the one hand and Y6 and the null value on the other hand, each connected to a set of an adder (31) and a shift register (35). The second stage (302) implements the submatrix M32 and comprises an adder (31) and a subtractor (32). The third stage (303) implements the submatrix M33 and comprises two adders (31) and two subtractors (32). Finally, the fourth stage (304) implements the submatrix M34 and comprises two adders (31) and two inverters (33) making it possible to supply up to four data at the input of four multiplexers MUX (34). Each multiplexer MUX is connected to a set consisting of an adder and a shift register, able to supply a final result (Z4 to Z7).

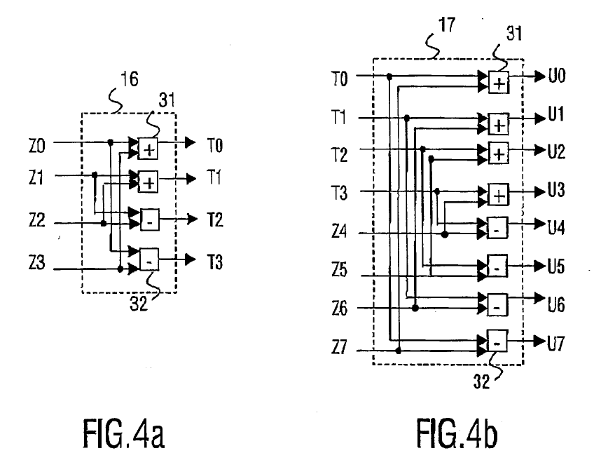

FIGS. 4a and 4b depict respectively linear combination means respectively for calculating a 4×4 and 8×8 IDCT.

According to the diagram in FIG. 4a, the linear combination means LC4 (16) correspond to the previously described matrix S_{4,4}. They comprise two adders (31) with the results T0=Z0+Z3 and T1=Z1+Z2, and two subtractors with the results T2=Z1−Z2 and T3=Z0−Z4.

According to the diagram in FIG. 4b, the linear combination means LC8 (17) correspond to the previously described matrix S_{8,8}. They comprise four adders (31) with the results U0=T0+Z7, U1=T1+Z6, U2=T2+Z5 and U3=T3+Z4. They also comp subtractors with the results U4=T3−Z4, U5=T2−Z5, U6=T1−Z6 and U7=T0−Z7.

The selection means SEL (19) then make it possible to select:

the data x0=Z0 and x1=Z1 issuing from the first scalable calculation module DA1 (12) for a 2×2 IDCT transformation;

the data x=T issuing from the linear combination means LC4 (16) for a 4×4 IDCT transformation;

the data x=U issuing from the linear combination means LC8 (17) for an 8×8 IDCT transformation;

or the data x issuing from the linear combination means LC16 (18) for a 16×16 IDCT transformation.

Consider now the case of a direct discrete cosine transformation.

Said transformation transforms data from the time domain into the frequency domain using the following equation:

$$X ( i , j ) = C ( i , j ) \cdot {\sum }_{m = 0}^{N - 1} {\sum }_{n = 0}^{N - 1} cos \frac{π ( 2 m - 1 ) i}{2 N} \cdot cos \frac{π ( 2 n + 1 ) j}{2 N} \cdot x ( m , n ) = M ( m , n ) \cdot x ( m , n )$$

For this purpose, the transformation matrix M can be decomposed into submatrices along a diagonal of said matrix, as follows, for a 16×16 DCT transformation:

M_{16×16}=P₁₆·B_{16×16}·S_{4,16}·S_{8,16}·S_{16,16}

The device for the direct transformation of original data (x) into transformed data (X) according to the invention, symmetrical with the inverse transformation device, thus comprises:

linear combination means (16, 17, 18) able to linearly combine the original data,

scalable calculation modules (12, 13, 14, 15) able to effect a product of data issuing from the linear combination means and a submatrix,

permutation means (11) able to reorder the data issuing from the scalable calculation modules according to a number of data to be processed, in order to supply the transformed data.

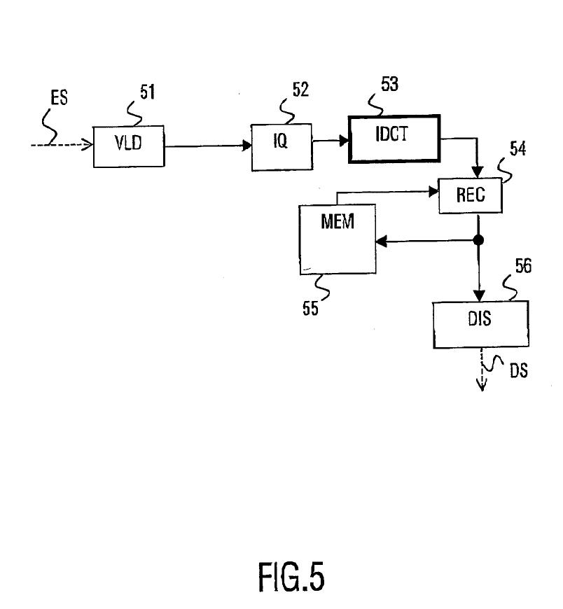

FIG. 5 depicts a video decoder for the decompression of compressed digital video data (ES) into decompressed digital video data (DS), said device comprising an inverse transformation device according to the invention.

The video decoder comprises:

means VLD (51) for the variable-length decoding of the compressed digital data able to supply quantized data,

means IQ (52) for the inverse quantization of the quantized data, able to supply transformed data,

a device IDCT (53) for the inverse discrete cosine transformation of transformed data into inversely transformed data as previously described.

The video decoder also comprises a step (54) of reconstruction REC of the block data image by blocks of data, by virtue of an image memory MEM (55), with a view to its display on a screen DIS (56).

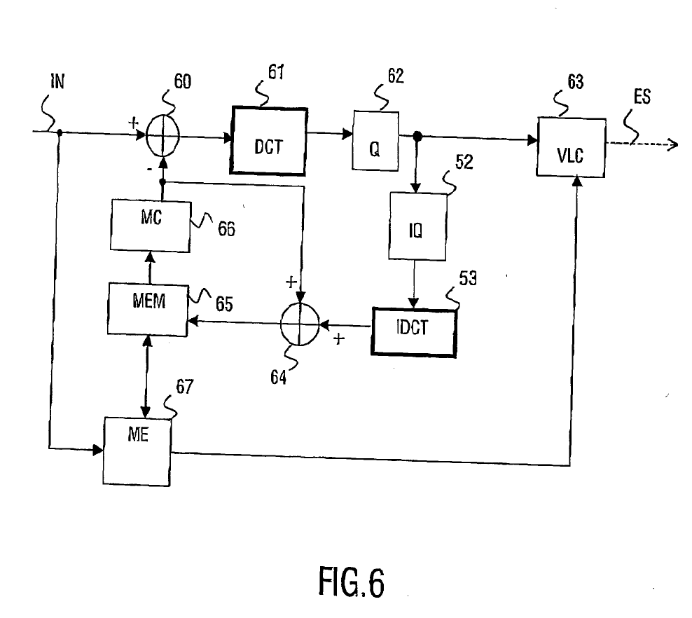

FIG. 6 depicts a video coder for the compression of input digital video data (IN) into compressed digital video data (ES). Said coder comprises a coding unit comprising:

a device for the direct discrete cosine transformation DCT (61) of digital video data into transformed data as previously described,

means (52) for the quantization Q of transformed data able to supply quantized data, and

means (63) for the variable-length coding VLC of quantized data able to supply compressed data.

The video coder possibly comprises a prediction unit comprising in series:

means (52) for the inverse quantization IQ of quantized data, able to supply transformed data,

a device (53) for the inverse discrete cosine transformation IDCT of transformed data into inversely transformed data, as previously described,

an adder (63) for the data issuing from the transformation device IDCT and a movement compensation device MC (66),

an image memory MEM (65) able to store the images used by the movement compensation device MC and a movement estimation device ME (67),

the movement compensation device MC, and

a subtractor (60) able to subtract the data issuing from the movement compensation device from the input digital video data (IN), the result from this subtractor being delivered to the transformation device DCT.

No reference sign between parentheses in the present text should be interpreted limitingly. The verb “comprise” and its conjugations should also be interpreted broadly, that is to say as not excluding the presence not only of elements or steps other than those listed after said verb but also a plurality of elements or steps already listed after said verb and preceded by the word “a” or “one”.

1. A device for the inverse transformation of transformed data (X) into inversely transformed data (x) via an inverse transformation matrix which can be decomposed into submatrices along a diagonal of the matrix, said device comprising:
permutation means (11) able to reorder the transformed data according to a number of data items to be processed,
scalable calculation modules (12, 13, 14, 15) able to produce a product of reordered transformed data and of a submatrix,
linear combination means (16, 17, 18) able to linearly combine the data issuing from the scalable calculation modules according to the number of data to be processed.

2. A transformed data processing device as claimed in claim 1, characterized in that the scalable calculation means are based on distributed arithmetic algorithms.

3. A transformed data processing device as claimed in claim 1, characterized in that it also comprises selection means (19) able to select the data issuing from a first scalable calculation module (12) or from linear combination means (16, 17, 18) according to the number of data to be processed, in order to supply the inversely transformed data.

4. A device for transforming original data (x) into transformed data (X) via a transformation matrix which can be decomposed into submatrices along a diagonal of the matrix, said device comprising:
linear combination means (16, 17, 18) able to linearly combine the original data,
scalable calculation modules (12, 13, 14, 15) able to produce a product of data issuing from the linear combination means and of a submatrix,
permutation means (11) able to reorder the data issuing from the scalable calculation modules according to a number of data to be processed, in order to supply the transformed data.

5. A video decoder comprising means for variable-length decoding (51) of the compressed digital data, able to supply quantized data, means (52) for the inverse quantization of the quantized data able to supply transformed data (X) and a device for the inverse transformation (53) of transformed data into inversely transformed data (x) as claimed in claim 1.

6. A video coder comprising a device (61) for transforming original data (x) into transformed data (X) as claimed in claim 4.

7. A video coder as claimed in claim 6, also comprising prediction means comprising a device (53) for the inverse transformation of transformed data (X) into inversely transformed data (x) as claimed in claim 1.

8. A method for the inverse transformation of transformed data (X) into inversely transformed data (x) via an inverse transformation matrix, characterized in that it comprises the steps of:
decomposition of the inverse transformation matrix into submatrices along a diagonal of the matrix,
calculation, intended to effect a product of transformed data and of a submatrix,
linear combination, intended to linearly combine the data issuing from the calculation step.

9. A method of transforming original data (x) into transformed data (X) via a transformation matrix, characterized in that it comprises the steps of:
decomposition of the transformation matrix into submatrices along a diagonal of the matrix,
linear combination, intended to linearly combine the original data,
calculation, intended to effect a product of data issuing from the linear combination step and of a submatrix.

10. A viewing apparatus, in particular a television receiver, comprising a video decoder as claimed in claim 5.
